(19) United States
(12) Patent Application Publication
(10) Pub. No.: US 2007/0138144 A1
(43) Pub. Date: Jun. 21, 2007

(54) Miniature electro-machining using carbon nanotubes

(76) Inventors: Chun Zhang, Tallahassee, FL (US); Zhiyong Liang, Tallahassee, FL (US); Ben Wang, Tallahassee, FL (US); Hsin-Yuan Miao, Taichung City (TW); Richard Wysk, Boalsburg, PA (US); Paul Cohen, State College, PA (US)

Correspondence Address: Pennington, Moore, Wilkinson, Bell & Dunbar, P.A.;2nd Floor, 215 S. Monroe Street, Post Office Box 10095, Tallahassee, FL, 32302-2095, US

(21) Appl. No.: 11/599,238

(22) Filed: Nov. 14, 2006

Related U.S. Application Data
(60) Provisional application No. 60/737,788, filed on Nov. 17, 2005.

(51) Int. Cl. B23H 1/00; B23K 9/00

(52) U.S. Cl. 219/69.11

(57) ABSTRACT

An electro-machining apparatus using one or more carbon nanotubes as an electrode. The nanotubes can be the single-walled or multi-walled variety. The electrode can be used in numerous electro-machining processes, including electrical discharge machining (“EDM”), electron beam machining (“EBM”), and electro-chemical machining.

### CROSS-REFERENCES TO RELATED APPLICATIONS

This application is a non-provisional application claiming the benefit of an earlier-filed provisional application pursuant to 37 C.F.R. §1.53(c). The provisional application listed the same inventors. It was filed on Nov. 17, 2005 and was assigned Ser. No. 60/737,788.

### STATEMENT REGARDING FEDERALLY SPONSORED RESEARCH OR DEVELOPMENT

Not applicable.

### MICROFICHE APPENDIX

Not Applicable

### BACKGROUND OF THE INVENTION

1. Field of the Invention

This invention relates to the field of machining. More specifically, the invention comprises the use of carbon nanotubes as electrodes for electro-machining.

2. Description of the Related Art

The present invention has applications in the field of electro-machining. The term “electro-machining” will be understood to broadly encompass any process using electricity to remove material. Examples include electrical discharge machining (“EDM”), electron beam machining (“EBM”), and electrochemical machining (“ECM”).

Electrical discharge machining (“EDM”) has been in common use for the past several decades. As it is likely the most common electro-machining process, it will be used for the examples in this disclosure. The EDM process places a high voltage on an electrode, then brings the electrode in close proximity to a workpiece. The workpiece—which must be conductive—is grounded. An electrical arc is created between the electrode and the workpiece, with the resulting high temperatures eroding the workpiece in the proximity of the arc.

EDM work can be broadly divided into two categories: ram and wire-cut. Wire-cut EDM operates like a bandsaw, with a moving wire being electrically charged and “sawing” into the workpiece. Ram EDM has traditionally involved machining a “male” carbon electrode to the desired shape, then slowly plunging this complex electrode into the workpiece to create a “female” cavity. In more recent years, some EDM machines have used a smaller “male”electrode, which is moved around by computer control to gradually erode the “female” cavity or other desired shape. This process is analogous to conventional milling operations, except that the material to be removed is eroded by an arc rather than cut by a cutter.

Electron-Beam Machining (“EBM”) has also been developed in recent years. Those skilled in the art will know that focused high-energy electron beams have been used in welding processes since the 1960's. Instead of electrical arcs, an electron gun is used to create a stream of focused electrons. Electrical coils can be positioned to focus and aim this beam. A substantial power density is possible. The electron beam locally vaporizes the material. Unlike EDM, EBM processes can be used on materials having lower conductivity. However, the workpiece and electron gun must generally be contained within an evacuated chamber.

EBM processes are well suited for comparatively deep drilling of very small diameter holes. A typical beam diameter is 0.01 mm. The EBM “drill” can drill holes in the range of 0.1 mm, with diameter-to-depth ratios up to 1:100. Material removal can be done very rapidly.

Both EDM and EBM processes require highly conductive electrodes. The electrode has traditionally limited the feature size that can be created using these processes. For small feature creation, copper, tungsten, or brass tube electrodes have been used. Such an electrode can plunge through the workpiece to create a hole. However, the electrode must have enough current carrying capacity to support the arc without melting itself. This limitation means that very small electrodes are impractical using copper or other conventional materials. Even where low current—and low production speed—can be tolerated, ultra-thin copper or tungsten electrodes are difficult to make. Thus, while EDM and EBM devices could theoretically cut very small features into a workpiece, a suitable electrode cannot be created for these operations using conventional materials.

### BRIEF SUMMARY OF THE INVENTION

The present invention comprises an electro-machining apparatus using one or more carbon nanotubes as an electrode. The nanotubes can be the single-walled or multi-walled variety. The electrode can be used in numerous electro-machining processes, including electrical discharge machining (“EDM”), electron beam machining (“EBM”), and electro-chemical machining. In the EDM application, a bundle of aligned carbon nanotubes can be employed to drill very small diameter holes. Larger bundles of single-walled or multi-walled nanotubes can be used to make larger holes. An array of carbon nanotubes can be used to create patterned holes or more complex features that are significantly larger than the diameter of a single carbon nanotube. The conductivity of the nanotubes can be enhanced by coating the nanotubes with a layer of metal. For more complex operations, one or more carbon nanotubes can be attached to a computer-controlled motion stage having two or more degrees of freedom. This moving motion stage can then be moved around to create intricate features on the workpiece.

### BRIEF DESCRIPTION OF THE SEVERAL VIEWS OF THE DRAWINGS

FIG. 1 is a perspective view, showing a single walled carbon nanotube.

FIG. 2 is a perspective view, showing a nanotube from one end.

FIG. 3 is a detail view, showing the arrangement of carbon atoms within a nanotube.

FIG. 4 is a perspective view, showing a nanotube attached to a nanotube holder.

FIG. 5 is a perspective view, showing a linear array of nanotubes.

FIG. 6 is a perspective view, showing a radial array of nanotubes.

FIG. 7 is a perspective view, showing a multi-wall nanotube.

FIG. 8 is a perspective view, showing a bundle of several single-walled nanotubes.

REFERENCE NUMERALS IN THE DRAWINGS

| | | | |
|---|---|---|---|
| 10 | carbon nanotube | 12 | carbon atom |
| 14 | carbon-carbon bond | 16 | nanotube holder |
| 18 | conductive probe | 20 | linear array |
| 22 | radial array | 24 | nanotube bundle |
| 26 | multi-wall nanotube | | |

### DESCRIPTION OF THE INVENTION

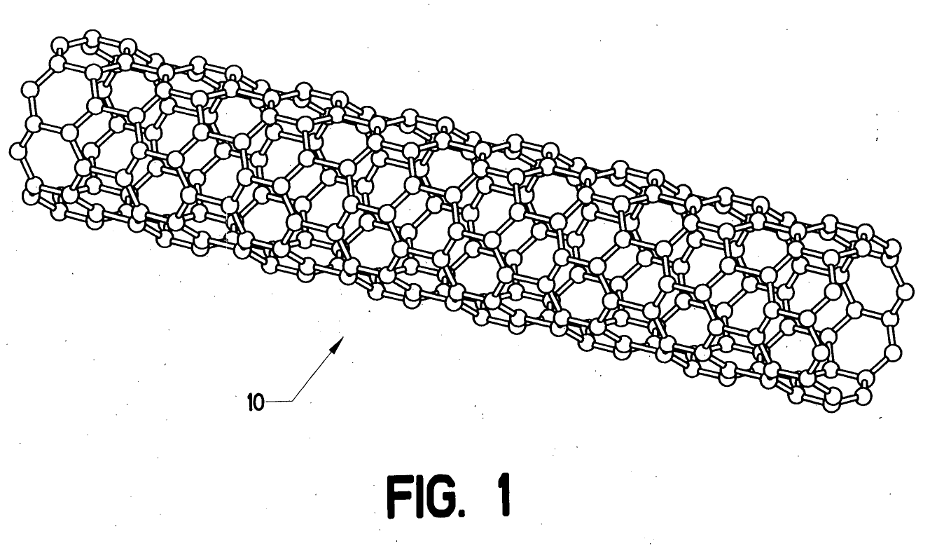

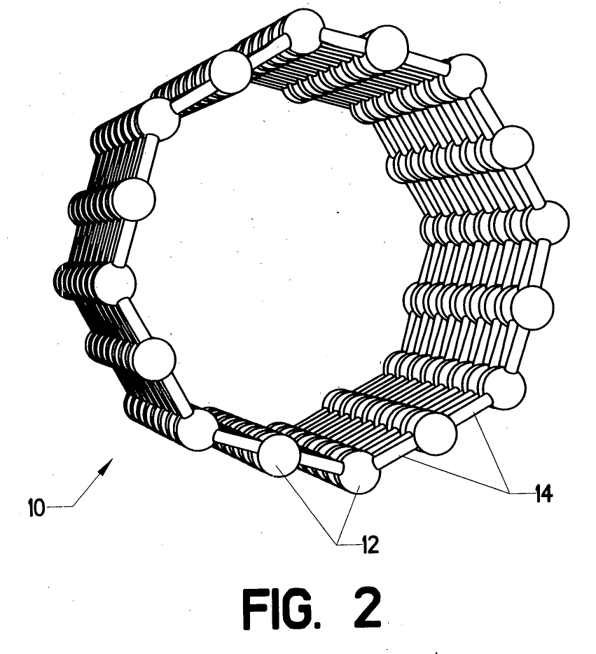

The present invention proposes to use one or more carbon nanotubes as an electrode for electrical discharge machining. FIG. 1 shows a single carbon nanotube 10. The version shown is commonly known as a single-walled nanotube (“SWNT”). It is comprised of a series of bonded carbon atoms arranged in a uniform and repeating pattern. FIG. 2 shows the same structure, viewed from one end to reveal its roughly cylindrical nature.

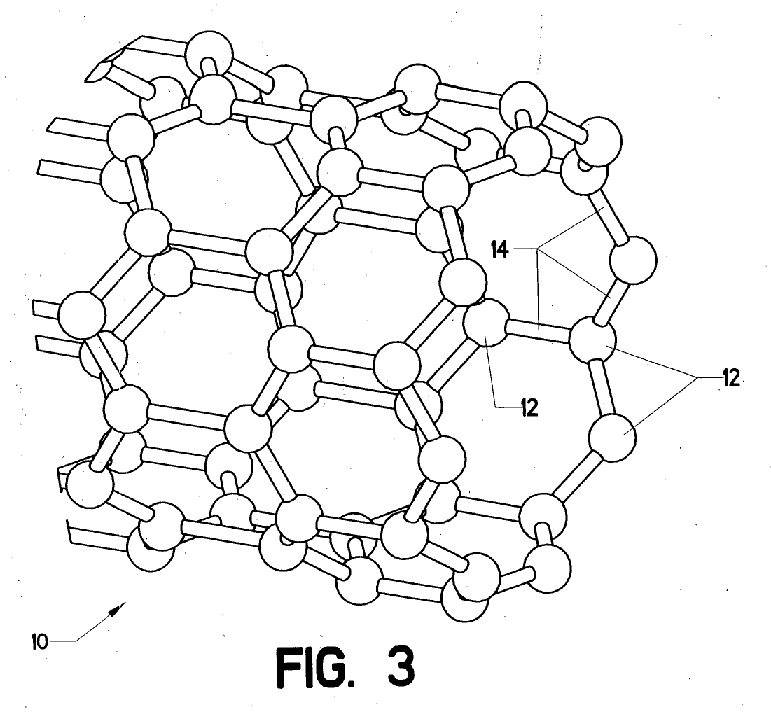

FIG. 3 shows a detailed view of a portion of the nanotube. The reader will note that its formed from a plurality of carbon atoms 12 interlinked by carbon-carbon bonds 14. A group of six carbon atoms form a hexagonal “cell.” These chain together to form rings, and ultimately the tube. Those skilled in the art will know that the carbon bonds are of the sp² type, similar to graphite. Such a nanotube has a diameter close to 1 nm. The tube length can be many thousands of times longer. The tube shown in FIG. 1, as an example, could be many times longer.

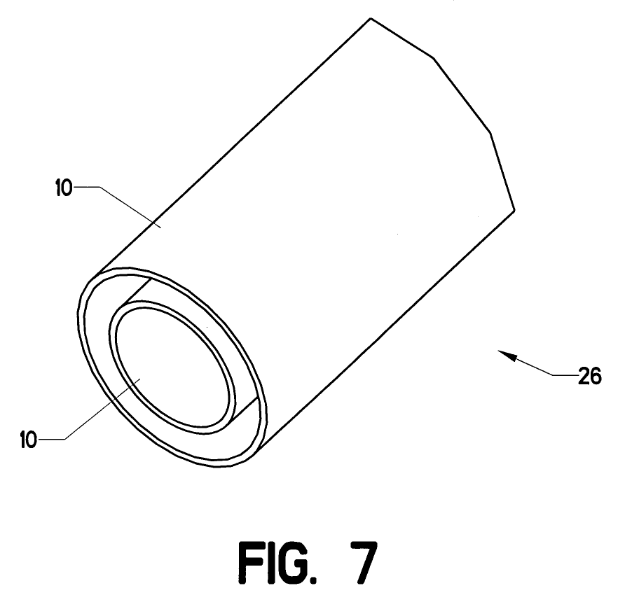

Carbon nanotubes are in fact difficult to form singly. They are more commonly formed as bundles of ten or more such tubes. Those skilled in the art will also know that carbon nanotubes are often formed with multiple concentric walls. A multi-walled nanotube typically comprises a concentric arrangement of two or more single-walled nanotubes. FIG. 7 shows multi-walled nanotube 26. The reader will observe that it comprises two concentric carbon nanotubes 10 having different diameters (The nanotubes are illustrated as simplified tubes).

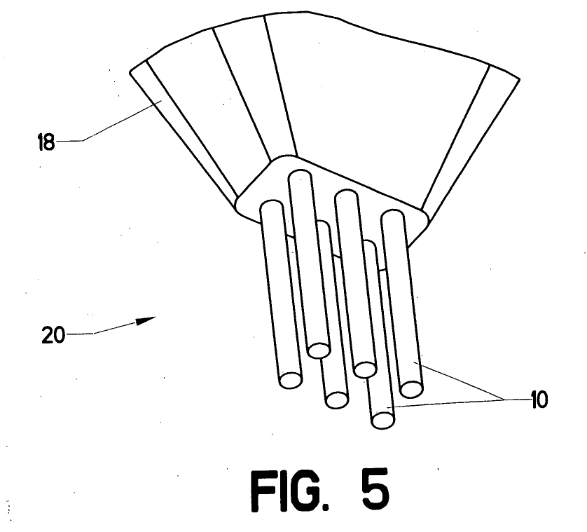

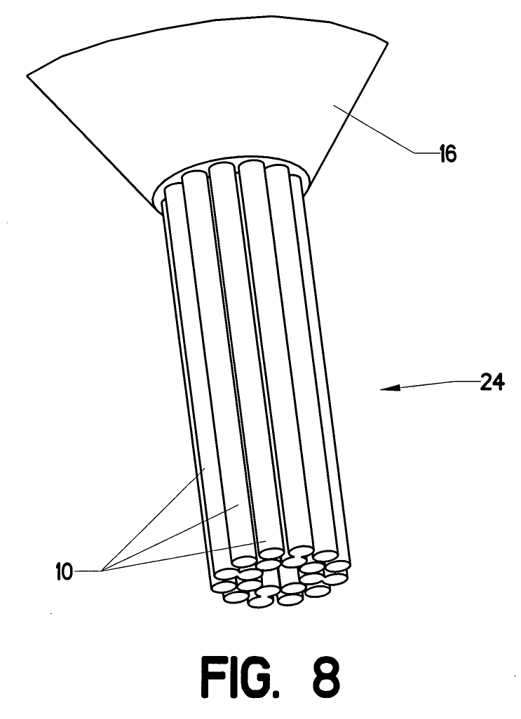

FIG. 8 illustrates a nanotube bundle 24, which includes over a dozen carbon nanotubes 10 packed closely together. The nanotubes comprising the bundle can be of the single-walled or multi-walled variety. Any of these variations can be used in the present invention. Many of the illustrations disclosed herein show a single carbon nanotube. The reader should bear in mind that whenever a single carbon nanotube is illustrated, a bundle of carbon nanotubes can be substituted therefor. This is also true for the illustrations of linear and radial arrays. These show arrangements of single carbon nanotubes. A bundle of carbon nanotubes can be substituted for each of the single carbon nanotubes shown. Thus, the linear array shown in FIG. 5 could just as easily be six nanotube bundles instead of six individual nanotubes.

Carbon nanotubes have several physical characteristics which favor their use in electro-machining processes. They have current carrying capacity roughly 1000 times greater than copper. This conductivity is also highly oriented. Looking at the structure of FIG. 1, electrical current will tend to flow in the direction of the tube's central axis. Nanotubes are also very stiff, meaning that they can withstand substantial mechanical force. Finally, nanotubes can be shaped into a variety of bulk-forming tools, such as small fibers, thin films, and bulk composite laminates. It may also be possible to form very small-diameter wires which could then be used for a wire EDM process.

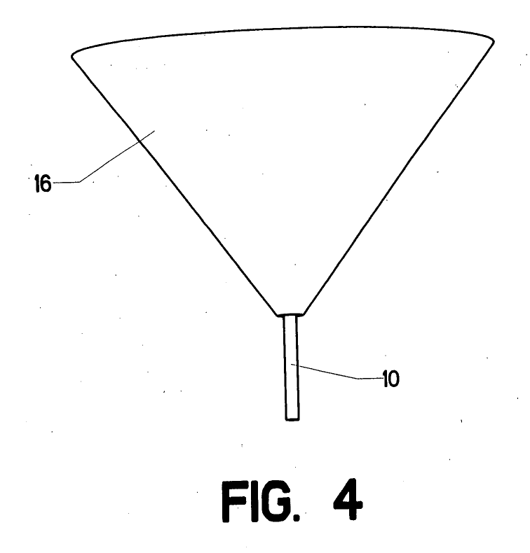

In order to use a nanotube bundle as an electrode, it must be attached to a larger conductor. Experiments have established the possibility of attaching one end of a nanotube to a nano-scale x, y, z motion stage. FIG. 4 shows a carbon nanotube 10 attached to nanotube holder 16 (A single nanotube is shown, but the reader should be aware that a bundle of nanotubes can be substituted for the single nanotube). Nanotube holder 16 has a very small point suitable for attaching the nanotube or a bundle of nanotubes. The probe grows larger proceeding toward its other end so that it can be gripped by more conventional mechanical features.

If nanotube holder 16 is made of conductive material, then carbon nanotube 10 can act as an EDM electrode. The larger end of the nanotube holder can be placed in a nano-scale x, y, z motion stage (similar to a three axis milling machine, but on a much smaller scale). Electrical current can be supplied through the nanotube holder. The moving head can then move the nanotube in a controlled fashion relative to a workpiece.

The simplest operation would be a plunging operation in which the carbon nanotube is used to “drill” a hole. For such an operation, the carbon nanotube would be slowly plunged into the workpiece, moving only in the -Z direction. The nanotube would therefore be able to produce a very small hole, having a diameter in the range of 1 to 10 nanometers.

Nanotubes having different diameters could be selected for the creation of different sized holes. However, there will be a significant range of hole sizes which would be too large for the largest single nanotube, yet still too small for the smallest conventional electrode. Within this range a larger array of nanotubes could be used.

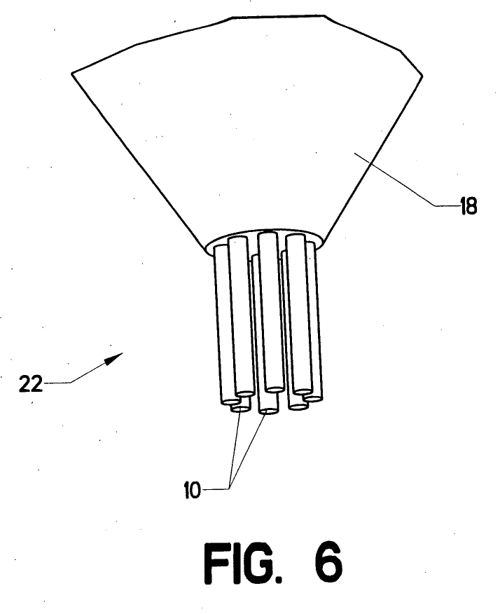

FIG. 5 shows a set of six nanotubes assembled in linear array 20. FIG. 6 shows a set of eight nanotubes assembled in radial array 22. The reader will note the existence of gaps between adjacent nanotubes. As these arrays are plunged into the workpiece, the arc can likely be adjusted to erode a section larger than the diameter of the nanotubes themselves. This enlarged erosion section may actually bridge the gap between adjacent nanotubes. For the linear array of FIG. 5, this would result in the production of a roughly rectangular cavity. For the radial array of FIG. 6, the assembly could act like a very small hole saw—eroding a ring into the workpiece.

Of course, depending on the arc size, workpiece material and other factors, the arc may not be able to bridge the gap between adjacent nanotubes. In this case, stepped motion of the array might be required. A brief example using the radial array of FIG. 6 will illustrate this point: Suppose the array is plunged into the workpiece to a depth of about one nanotube diameter. This action will produce a set of eight evenly spaced holes in the workpiece. The assembly is then withdrawn and rotated about 22.5 degrees and plunged a second time to erode away the webs between the original holes.

The linear array of FIG. 5 can be plunged, withdrawn, translated sideways, and plunged again in order to create an elongated slot. Careful control of the electrode motion and the feeding voltage and current can be used to move the nanotubes around the workpiece in a controlled fashion, thereby creating very small (and possibly quite complex) features. The directional conductivity of the carbon nanotubes will obviously be a factor in designing and using such arrays. The electrical current tends to flow along the carbon nanotubes central axis. Thus, an arc will tend to “jump” to the workpiece in the vicinity of the nanotube's free end, rather than at some other point along its length.

Those skilled in the art will know that the EDM-based example of FIG. 5 can function in a similar fashion to a large-scale computer-numerically-controlled milling machine (“CNC machine”). A CNC machine's motion is controlled by a computer running software. The software directs the motion of the cutting head through a series of predetermined steps. Using this sequence, a relatively small cutter can be used to cut away material and produce a much larger and more intricately shaped cavity. The carbon nanotube electrode can be moved through an analogous series of predetermined steps in order to sequentially erode material using an electrical arc. The nano-scale motion stage obviously travels through a much smaller range of motion than the CNC machine, but the principles are similar.

The use of carbon nanotubes as EDM electrodes is not limited to tubular structures. Those skilled in the art will know that carbon nanotubes, carbon nanotube films, and their composites can be shaped into different forms having different shapes. Examples include nano or micro fibers, nanotube bundles or ropes, thin films (“buckypapers”), and composite laminates. The carbon nanotubes include single-walled carbon nanotubes (SWNT's) and multi-walled carbon nanotubes (MWNT's). These structures could be used for nano-EDM, micro-EDM, micro wire EDM, or other electro-machining processes. The nanotube-based electro-machining processes can make features on workpieces of conductive and semi-conductive materials.

While the full breadth of applications for such electro-machining processes is presently difficult to anticipate, one possibility is their use in the polishing process for silicon wafers. This would allow the reduction or elimination of current chemical-mechanical polishing, which generates toxic by-products.

Although the preceding description contains significant detail, it should not be construed as limiting the scope of the invention but rather as providing illustrations of the preferred embodiments of the invention. As an example, although simple linear and radial arrays of carbon nanotubes have been illustrated, much more complex arrays are possible. Such complex arrays could be used to create intricate features using a single plunge operation. As a further example, although the use of the carbon nanotubes in EDM processes has been primarily discussed, the reader should bear in mind that the nanotubes can be applied to other electro-machining processes. Accordingly, the scope of the invention should be fixed by the following claims rather than any specific examples given.

Having described our invention, we claim:

1. An electro-machining apparatus for performing operations on a workpiece, comprising:
a. at least one carbon nanotube, wherein said at least one carbon nanotube has a first end, a second end, and a longitudinal axis extending from said first end to said second end;
b. a nanotube holder, attached to said first end of said carbon nanotube, wherein said nanotube holder is made from electrically conductive material;
c. an electrical current supply, electrically connected to said nanotube holder; and
d. a motion stage, for controllably moving said nanotube holder in order to bring said second end of said carbon nanotube to a desired position relative to the position of said workpiece.

2. An electro-machining apparatus as recited in claim 1, wherein said at least one carbon nanotube is of the single-wall type.

3. An electro-machining apparatus as recited in claim 1, wherein said at least one carbon nanotube is of the multi-wall type.

4. An electro-machining apparatus as recited in claim 1, further comprising additional carbon nanotubes arranged around said at least one carbon nanotube to form a bundle.

5. An electro-machining apparatus as recited in claim 4, wherein said at least one carbon nanotube and said additional carbon nanotubes are of the single-wall type.

6. An electro-machining apparatus as recited in claim 4, wherein said at least one carbon nanotube and said additional carbon nanotubes are of the multi-wall type.

7. An electro-machining apparatus as recited in claim 4, wherein said bundle of carbon nanotubes are arranged in a linear array.

8. An electro-machining apparatus as recited in claim 4, wherein said bundle of carbon nanotubes are arranged in a radial array.

9. An electro-machining apparatus as recited in claim 4, wherein said bundle of carbon nanotubes comprise a mixture of single-wall and double-wall types.

10. An electro-machining apparatus as recited in claim 1, wherein said motion stage moves along an x axis.

11. An electro-machining apparatus as recited in claim 10, wherein said motion stage additionally moves along a y axis.

12. An electro-machining apparatus as recited in claim 11, wherein said motion stage additionally moves along a z axis.

13. An electro-machining apparatus as recited in claim 12, wherein said motion of said motion stage is controlled by a computer.

14. An electro-machining apparatus as recited in claim 13, wherein said computer runs software directing said motion of said motion stage such that said electrode is moved through a plurality of predetermined motions.

15. An electro-machining apparatus as recited in claim 14, further comprising additional carbon nanotubes arranged around said at least one carbon nanotube to form a bundle.

16. An electro-machining apparatus as recited in claim 15, wherein said bundle of carbon nanotubes are arranged in a linear array.

17. An electro-machining apparatus as recited in claim 15, wherein said bundle of carbon nanotubes are arranged in a radial array.

18. An electro-machining apparatus as recited in claim 15, wherein said carbon nanotubes comprising said bundle are of the single-wall type.

19. An electro-machining apparatus as recited in claim 15, wherein said carbon nanotubes comprising said bundle are of the multi-wall type.

20. An electro-machining apparatus as recited in claim 15, wherein said bundle of carbon nanotubes comprise a mixture of single-wall and double-wall types.
